(19) United States
(12) Patent Application Publication
(10) Pub. No.: US 2006/0077547 A1
(43) Pub. Date: Apr. 13, 2006

(54) Diffusely reflective polarizing film, display apparatus having the same, and method of manufacturing the same

(75) Inventors: Jin-Sung Choi, Yongin-si (KR); Jong-Dae Park, Seoul (KR); Dong-Hoon Kim, Seoul (KR); Jheen-Hyeok Park, Seongnam-si (KR); Jeong-Hwan Lee, Suwon-si (KR); Jin-Mi Jung, Seoul (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 11/245,112

(22) Filed: Oct. 7, 2005

(30) Foreign Application Priority Data
Oct. 8, 2004 (KR) 10-2004-0080541
Mar. 3, 2005 (KR) 10-2005-0017695

(51) Int. Cl. G02B 27/28

(52) U.S. Cl. 359/487

(57) ABSTRACT

A diffusing reflective polarizing film has a liquid crystal film and a diffusing layer. The liquid crystal film includes a cholesteric liquid crystal diffusely reflecting a first component of a light substantially in parallel with a twisted axis of the cholesteric liquid crystal and transmitting a second component of the light different from the first component. The diffusing layer is attached to the liquid crystal layer to diffuse light from the liquid crystal layer. Thus, the diffusely reflective polarizing film may improve brightness uniformity, thereby preventing a warping phenomenon of the diffusely reflective polarizing film.

### CROSS-REFERENCE TO RELATED APPLICATIONS

This application claims priority to and the benefit of Korean Patent Application No. 10-2004-0080541 filed on Oct. 8, 2004, and Korean Patent Application No. 10-2005-0017695 filed on Mar. 3, 2005, which are hereby incorporated by reference for all purposes as if fully set forth herein.

### BACKGROUND OF THE INVENTION

1. Field of the Invention

The present invention relates to a diffusely reflective polarizing film, a display apparatus having the same and a method of manufacturing the same. More particularly, the present invention relates to a diffusely reflective polarizing film to improve display quality, a display apparatus having the diffusely reflective polarizing film, and a method of manufacturing the diffusely reflective polarizing film.

2. Description of the Related Art

A liquid crystal display apparatus is a flat panel display apparatus that displays an image using liquid crystal. The liquid crystal display apparatus weighs less, consumes less power, has a lower driving voltage, etc., than other types of display apparatus, such as a cathode ray tube, a plasma display panel, etc.

The liquid crystal display apparatus requires a light source device to generate a light since the display panel is not self-emissive.

The light source device is generally a tubular-shaped cold cathode fluorescent lamp. The light source device is classified as either an edge illumination type light source device or a direct illumination type according to an installed position of a lamp.

The edge illumination type light source device has one or two light sources positioned adjacent to a side face of a transparent light guide plate. The light emitted from the light source is multiply reflected from a face of the light guide plate and is supplied to a liquid crystal display panel on which the image is displayed.

The direct illumination type light source device includes a plurality of light sources, disposed under the liquid crystal display panel, a diffusing plate disposed over the light sources and a reflecting plate under the light sources. The light from the light source is reflected from the reflecting plate and supplied to the liquid crystal display panel after being diffused by the diffusing plate.

In a conventional liquid crystal display apparatus, assuming that a light intensity of light emitted from the light source device is 100%, a light intensity of light emitted from the liquid crystal display panel is approximately 7%. When the light emitted from the light source device has a brightness uniformity of approximately 76.3%, the light emitted from the liquid crystal display panel has a brightness uniformity that is approximately 69.7% less than the brightness uniformity of the light from the light source. As the above described, since the light intensity and the brightness uniformity are each reduced, display quality of the liquid crystal display apparatus deteriorates or worsens.

### SUMMARY OF THE INVENTION

The present invention provides a diffusely reflective polarizing film capable of improving a display quality of a display apparatus.

The present invention also provides a display apparatus having the above diffusely reflective polarizing film.

The present invention also provides a method suitable for manufacturing the above diffusely reflective polarizing film.

Additional features of the invention will be set forth in the description which follows, and in part will be apparent from the description, or may be learned by practice of the invention.

The present invention discloses diffusely reflective polarizing film including a liquid crystal film having a cholesteric liquid crystal to reflect a first component of an incident light and to transmit a second component of the light; and a diffusing layer attached with the liquid crystal film, wherein the first component is substantially parallel with a rotated axis of the cholesteric liquid crystal, and the second component is different than the first component.

The present invention also discloses a diffusely reflective polarizing film, including a base film; and a plurality of polarizing particles including a copolymer, wherein the base film includes the polarizing particles to transmit a first component of a light supplied to the base film and to diffusely reflect a second component of the light.

The present invention also discloses a diffusely reflective polarizing film including a base film; a plurality of organic particles provided in the base film to transmit a first component of a light supplied to the base film and diffusely reflect a second component of the light; and a diffusing layer attached with the base film.

The present invention also discloses a display apparatus, including a backlight assembly generating a light; a diffusely reflective polarizing film provided on the backlight assembly and including a liquid crystal film including a cholesteric liquid crystal to reflect a first component of the light that is substantially parallel with a rotated axis of the cholesteric liquid crystal and to transmit a second component of the light that is different from the first component; and a diffusing layer attached with the liquid crystal layer, and a display panel provided on the diffusely reflective polarizing film that displays an image using the light supplied from the diffusely reflective polarizing film.

The present invention also discloses a display apparatus, including a backlight assembly generating a light; a diffusely reflective polarizing film provided on the backlight assembly and including a base film; and a plurality of polarizing particles including a copolymer, and a display panel provided on the diffusely reflective polarizing film that displays an image using the light from the diffusely reflective polarizing film, wherein the base film includes the polarizing particles to transmit a first component of the light supplied to the base film and to diffusely reflect a second component of the light.

The present invention also discloses a display apparatus, including a backlight is assembly generating a light; a diffusely reflective polarizing film provided on the backlight assembly and including a base film; a plurality of organic particles provided in the base film to transmit a first component of a light supplied to the base film and to diffusely reflect a second component of the light; and a diffusing layer attached with the base film, and a display panel provided on the diffusely reflective polarizing film that displays an image using the light from the diffusely reflective polarizing film.

The present invention also discloses a method of manufacturing a diffusely reflective polarizing film, including forming a liquid crystal film having a cholesteric liquid crystal to reflect a first component of a light and to transmit a second component of the light, the first component is substantially parallel with a rotated axis of the cholesteric liquid crystal and the second component is different from the first component; and attaching a diffusing layer with the liquid crystal layer.

he present invention also discloses a method of manufacturing a diffusely reflective polarizing film, including expanding a base film that comprises a plurality of organic particles comprising a core-shell-like structure; and attaching a diffusing layer with the base film.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a cross-sectional view showing a diffusely reflective polarizing film according to an embodiment of the invention.

FIG. 2 is a cross-sectional view showing a liquid crystal film in FIG. 1.

FIG. 3 is a view showing a liquid crystal layer in FIG. 2.

FIG. 4 is a cross-sectional view showing a diffusely reflective polarizing film according to an embodiment of the invention.

FIG. 5 is a cross-sectional view showing a diffusely reflective polarizing film according to an embodiment of the invention.

FIG. 6 is a cross-sectional view illustrating a manufacturing process of the diffusely reflective polarizing film in FIG. 1.

FIG. 7A is a view showing first and second ultraviolet adhesive materials before being cured by an ultraviolet light in FIG. 1.

FIG. 7B is a view showing the first and second ultraviolet adhesive materials after being cured by an ultraviolet light in FIG. 1.

FIG. 8 is a cross-sectional view showing a display apparatus having the diffusely reflective polarizing film in FIG. 1.

FIG. 9 is a cross-sectional view showing a diffusely reflective polarizing film according to an embodiment of the invention.

FIG. 10 is a sectional perspective view schematically showing a base film in FIG. 9.

FIG. 11 is a cross-sectional view showing an organic particle added in the base film in FIG. 9.

FIG. 12 is a cross-sectional view illustrating a manufacturing process of the diffusely reflective polarizing film in FIG. 9.

FIG. 13 is a cross-sectional view showing a display apparatus having the diffusely reflective polarizing film in FIG. 9.

### DESCRIPTION OF THE ILLUSTRATED EMBODIMENTS

It is understood that when an element or layer is referred to as being “on”, “connected to” or “coupled to” another element or layer, the element can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It is understood that, although the terms first, second, etc. may be used herein to describe various elements, components, regions, layers and/or sections, these elements, components, regions, layers and/or sections are not be limited by these terms. These terms are only used to distinguish one element, component, region, layer or section from another region, layer or section. Thus, a first element, component, region, layer or section discussed below may be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, when the device in the figures is turned over, elements described as “below” or “beneath” other elements or features are then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It is understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It is understood that terms, such as those defined in commonly used dictionaries, should be interpreted as having a meaning that is consistent with their meaning in the context of the relevant art and will not be interpreted in an idealized or overly formal sense unless expressly so defined herein.

The invention is described below with reference to the accompanying drawings.

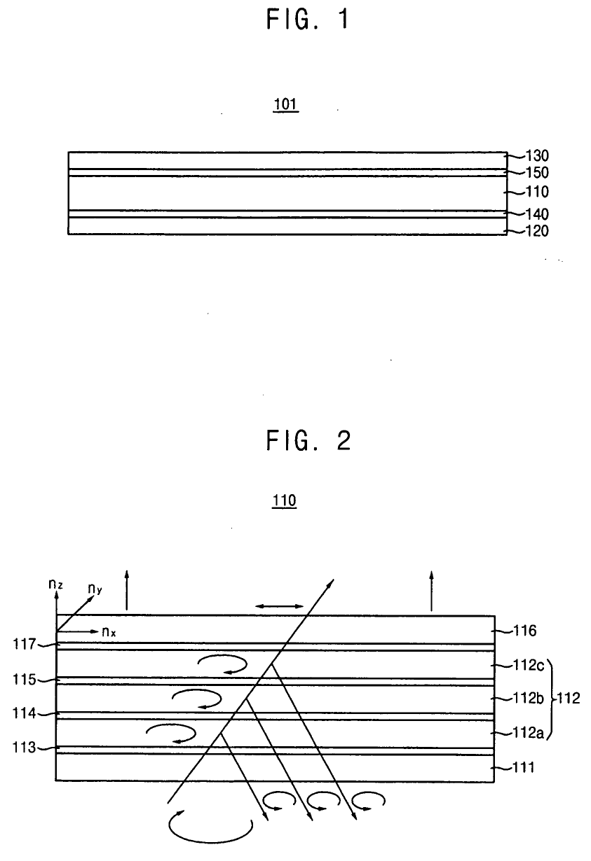

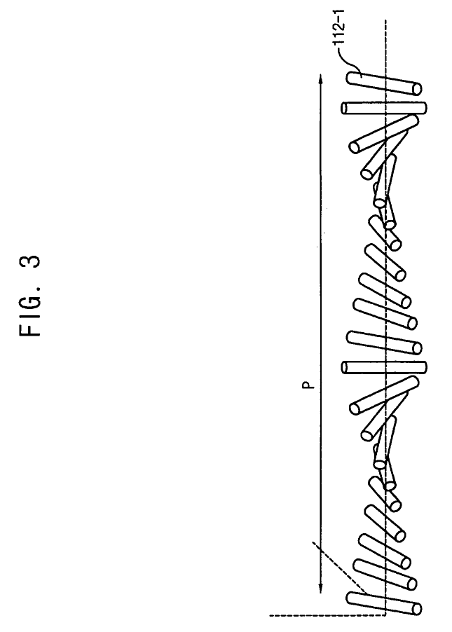

FIG. 1 is a cross-sectional view showing a diffusely reflective polarizing film according to an embodiment of the invention. FIG. 2 is a cross-sectional view showing a liquid is crystal film in FIG. 1. FIG. 3 is a view showing a liquid crystal layer in FIG. 2.

Referring to FIG. 1, a diffusely reflective polarizing film 101 includes a liquid crystal film 110, a first diffusing layer 120, a second diffusing layer 130, a first ultraviolet adhesive 140, and a second ultraviolet adhesive 150.

The first diffusing layer 120 is provided, e.g., disposed, under the liquid crystal film 110 to diffuse a light supplied to the liquid crystal film 110. The first diffusing layer 120 is attached with a lower surface of the liquid crystal film 110 by the first ultraviolet adhesive 140. The first ultraviolet adhesive 140 is provided between the first diffusing layer 130 and the liquid crystal film 110. The second diffusing layer 130 is disposed over the liquid crystal film 110 to diffuse the light emitted from the liquid crystal film 110.

The second diffusing layer 130 is attached with an upper surface of the liquid crystal film 110 by the second ultraviolet adhesive 150. The second ultraviolet adhesive 150 is provided between the second diffusing layer 130 and the liquid crystal film 110. Each of the first and second diffusing layers 120 and 130 is approximately ten micrometers to approximately three hundred micrometers thick, e.g., preferably having a thickness of approximately thirty-four micrometers.

To protect the liquid crystal film 110 from heat and/or moisture, the first and second diffusing layers 120 and 130 have a lower thermal expansion ratio and a lower water absorbance than the liquid crystal film 110. For example, the first and second diffusing layers 120 and 130 may include a polycarbonate-based resin, a polysulfone-based resin, a polymethylmethacrylate-based resin, a polystyrene-based resin, a polyvinylchloride-based resin, a polyvinylalcohol-based resin, a polynorbornene-based resin, etc., alone or in a combination thereof. Thus, the first and second diffusing layers 120 and 130 may prevent or significantly reduce the warping phenomenon of the liquid crystal film 110 that results from the heat and/or moisture.

A diffusing agent may be added to the first and second diffusing layers 120 and 130 to diffuse a light that is supplied to the first and second diffusing layers 120 and 130, thereby improving a brightness uniformity of light passing through the first and second diffusing layers 120 and 130. The diffusing agent may include a silicon diffusing agent, a magnesium diffusing agent or a calcium carbonate diffusing agent. To prevent or significantly reduce a static electricity from being provided to the liquid crystal film 110, a cationic surfactant may be added to the first and second diffusing layers 120 and 130.

The first and second ultraviolet adhesives 140 and 150 are cured by exposure to an ultraviolet light and attach the first and second diffusing layers 120 and 130 with the lower and upper surfaces of the liquid crystal film 110, respectively.

The first and second ultraviolet adhesives 140 and 150 may include a photopolymerizeable initiator, a photopolymerizeable monomer, and a photopolymerizeable oligomer. For example, the photopolymerizeable initiator may include an acetophenone-based initiator, a benzophenone-based initiator, a thioxanthone-based initiator, or the like. The photopolymerizeable monomer may include an acrylate-based monomer, an epoxy acrylate-based monomer, a polyester acrylate-based monomer, an urethane acrylate-based monomer, or the like. The photopolymerizeable oligomer may include an acrylate-based oligomer, an epoxy acrylate-based oligomer, a polyester acrylate-based oligomer, an urethane acrylate-based oligomer, or the like. The first and second ultraviolet adhesives 140 and 150 are described below with reference to FIG. 7A and FIG. 7B.

As shown in FIG. 2, the liquid crystal film 110 includes a base layer 111, a liquid crystal layer 112, and a retardation layer 116. The base layer 111 may include a polyethyleneterephthalate-based resin.

The liquid crystal layer 112 is formed on the base layer 111 and may include a cholesteric liquid crystal to circularly polarize the light that passes through the base layer 111.

The liquid crystal layer 112 may include a first liquid crystal layer 112a to circularly polarize a light having a red wavelength range, a second liquid crystal layer 112b to circularly polarize a light having a green wavelength range, and a third liquid crystal layer 112c to circularly polarize a light having a blue wavelength range. The first, second, and third liquid crystal layers 112a, 112b and 112c may be sequentially stacked on the base layer 111.

The liquid crystal film 110 may include a first adhesive 113, a second adhesive 114 and a third adhesive 115. The first adhesive 113 attaches the first liquid crystal layer 112a with an upper surface of the base layer 111, the second adhesive 114 attaches the second liquid crystal layer 112b with an upper surface of the first liquid crystal layer 112a, and the third adhesive 115 attaches the third liquid crystal layer 112c with an upper surface of the second liquid crystal layer 112b.

The first, second, and third liquid crystal layers 112a, 112b, and 112c may be made of a material that includes a mixture of the cholesteric liquid crystal, a vertical alignment liquid crystal, and an ultraviolet initiator, which are mixed together and a solvent is added thereto in a predetermined ratio. For example, in the first, second and third liquid crystal layers 112a, 112b and 112c, the cholesteric liquid crystal and the vertical alignment liquid crystal may be mixed into a solvent at a different ratio from each other so that the first, second and third liquid crystal layers 112a, 112b, and 112c diffusely reflect a light having a different wavelength range from each other.

For example, the first liquid crystal layer 112a may include a mixture of the cholesteric liquid crystal and the vertical alignment liquid crystal mixed into the solvent in a ratio of 8:2. The second liquid crystal layer 112b may include a mixture of the cholesteric liquid crystal and the vertical alignment liquid crystal into the solvent at a ratio of 7:3. The third liquid crystal layer 112c may include a mixture of the cholesteric liquid crystal and the vertical alignment liquid crystal into the solvent at a ratio of 6:4.

As shown in FIG. 3, the cholesteric liquid crystal 112-1 may include a substantially stick-shaped liquid crystal molecules that is twisted in a substantially spiral shape. The liquid crystal molecules are repeatedly twisted in a predetermined interval, e.g., a pitch P defines an interval of which the liquid crystal molecules are twisted.

The first, second, and third liquid crystal layers 112a, 112b, and 112c may each have a different pitch from each other. The pitches of the first, second, and third liquid crystal layers 112a, 112b, and 112c may increase in that order. Each of the first, second and third liquid crystal layers 112a, 112b, and 112c polarizes light having a wavelength range determined by multiplying the pitch P thereof by a refractive index of the cholesteric liquid crystal 112-1 therein.

The first, second, and third liquid crystal layers 112a, 112b, and 112c reflect a first component of an incident light that is substantially parallel with a twisted direction of the cholesteric liquid crystal 112-1, and transmit a second component of the incident light that is different from the first component of the light. Thus, the first component of the light is right circularly polarized or left circularly polarized by the first, second, and third liquid crystal layers 112a, 112b, and 112c according to the twisted direction of the cholesteric liquid crystal 112-1. On the contrary, the second component of the light is circularly polarized in a direction that is opposite to the first component.

The light reflected from the first, second, and third liquid crystal layers 112a, 112b and 112c is incident upon the first, second, and third liquid crystal layers 112a, 112b, and 112c. That is, most of the light is circularly polarized while the light transmits through the first, second, and third liquid crystal layers 112a, 112b, and 112c.

Referring to FIG. 2, the retardation layer 116 is provided on the third liquid crystal layer 112c. A fourth adhesive 117 is provided between the retardation layer 116 and the third liquid crystal layer 112c. The fourth adhesive 117 attaches the retardation layer 116 with an upper surface of the third liquid crystal layer 112c. The retardation layer 116 linearly polarizes the circularly polarized light from the liquid crystal layer 112. The linearly polarized light that passed through the retardation layer 116 has a p-polarized component.

The retardation layer 116 may include a λ/4 retardation layer. When a z-axis refractive index (n_{z}) of the retardation layer 116 is larger than an x-axis refractive index (nₓ) and a y-axis refractive index (n_{y}) of the retardation layer 116 with respect to x-y plane, the retardation layer 116 has a phase delay value of between approximately 110 nm to approximately 125 nm.

Table 1 represents the x-axis, y-axis, and z-axis refractive indexes nₓ, n_{y} and n_{z} of the retardation layer 116 in accordance with Example 1 and Example 2.

TABLE 1

| | nₓ | n_{y} | n_{z} |
|---|---|---|---|
| Example 1 | 1.5806 | 1.5783 | 1.5841 |
| Example 2 | 1.5823 | 1.5795 | 1.5837 |

In Example 1, the x-axis refractive index nₓ is approximately 1.5806, the y-axis refractive index n_{y} is approximately 1.5783, and the z-axis refractive index n_{z} is approximately 1.5841. Also, in Example 2, the x-axis refractive index nₓ is approximately 1.5823, the y-axis refractive index n_{y} has about 1.5795, and the z-axis refractive index n_{z} is approximately 1.5837. In Example 1 and Example 2, when the z-axis refractive index n_{z} of the retardation layer 116 is larger than the x-axis and y-axis refractive indexes nₓ and n_{y} of the retardation layer 116, the retardation layer 116 has the phase delay value of between approximately 110 nm and approximately 125 nm.

When the phase delay value of the retardation layer 116 is between approximately 110 nm and approximately 125 nm, a brightness of the light passed through the retardation layer 116 may be enhanced, and x-color coordinate value and a y-color coordinate value of the light that passed through the retardation layer 116 may increase.

According to an embodiment of the invention, the base film 111 may be approximately 188 μm thick, and each of the first, second and third liquid crystal layers 112a, 112b, and 112c may be approximately four μm thick. Each of the first, second and third adhesives 113, 114, and 115 may be approximately one μm thick. The retardation layer 116 may be approximately thirty μm thick. The fourth adhesive 117 may be approximately twenty μm thick. Therefore, the liquid crystal film 110 is approximately 273 μm thick.

The liquid crystal film 110 may further include a first dummy liquid crystal layer (not shown), a second dummy liquid crystal layer (not shown), and a third dummy liquid crystal layer (not shown). The first liquid crystal layer 112a and the first dummy liquid crystal layer circularly polarize a light having the red wavelength range. The second liquid crystal layer 112b and the second dummy liquid crystal layer circularly polarize a light having the green wavelength range. The third liquid crystal layer 112c and the third dummy liquid crystal layer circularly polarize a light having the blue wavelength range.

When the liquid crystal film 110 further includes the first, second, and third dummy liquid crystal layers, the liquid crystal film is approximately 288 μm thick.

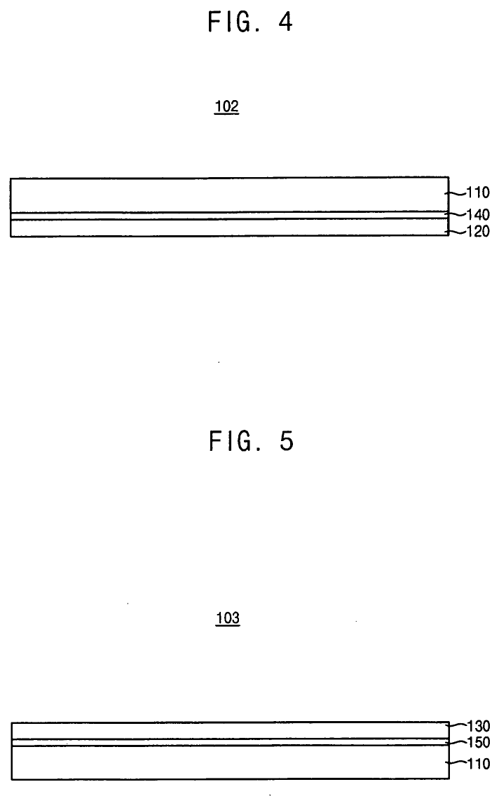

FIG. 4 is a cross-sectional view showing a diffusely reflective polarizing film according to another embodiment of the invention. In FIG. 4, the same reference numerals denote the same elements in FIG. 1 and repetitive descriptions of the same elements are omitted as necessary.

Referring to FIG. 4, a diffusely reflective polarizing film 102 includes the liquid crystal film 110, the first diffusing layer 120, and the first ultraviolet adhesive 130. The first diffusing layer 120 is provided below the liquid crystal film 110 to diffuse the light supplied to the liquid crystal film 110. The first ultraviolet adhesive 130 attaches the first diffusing layer 120 with the lower surface of the liquid crystal film 110.

A resin may used for the first diffusing layers 120 that includes a polycarbonate-based resin, a polysulfone-based resin, a polymethylmethacrylate-based resin, a polystyrene-based resin, a polyvinylchloride-based resin, a polyvinylalcohol-based resin, a polynorbornene-based resin, etc., either alone or in a combination thereof. Therefore, the first diffusing layer 120 may prevent the warping phenomenon of the liquid crystal film 110 that results the heat and/or the moisture.

A diffusing agent may be added to the first diffusing layers 120 to diffuse a light that is supplied to the first diffusing layer 120. The diffusing agent may include a silicon diffusing agent, a magnesium diffusing agent, or a calcium carbonate diffusing agent, to improve a brightness uniformity of a light passed through the first and second diffusing layers. A cationic surfactant may also be added to the first diffusing layer 120 to prevent static electricity from being provided to the liquid crystal film 110.

The first ultraviolet adhesive 140 is cured by an exposure of an ultraviolet that attaches the first diffusing layer 120 with the lower surface of the liquid crystal film 110. The first ultraviolet adhesive 140 includes a photopolymerizeable initiator, a photopolymerizeable monomer, and a photopolymerizeable oligomer. The photopolymerizeable initiator may include an acetophenone-based initiator, a benzophenone-based initiator or a thioxanthone-based initiator. The photopolymerizeable monomer may include an acrylate-based monomer, an epoxy acrylate-based monomer, a polyester acrylate-based monomer, an urethane acrylate-based monomer, etc. The photopolymerizeable oligomer may include an acrylate-based oligomer, an epoxy acrylate-based oligomer, a polyester acrylate-based oligomer, an urethane acrylate-based oligomer, etc.

FIG. 5 is a cross-sectional view showing a diffusely reflective polarizing film according to another embodiment of the invention. In FIG. 5, the same reference numerals denote the same elements as shown in FIG. 1 and any repetitive descriptions of the same elements are omitted as necessary.

Referring to FIG. 5, a diffusely reflective polarizing film 103 includes the liquid crystal film 110, the second diffusing layer 130, and the second ultraviolet adhesive 150. The second diffusing layer 130 is provided over the liquid crystal film 110 to diffuse the light that passed through the liquid crystal film 110. The second ultraviolet adhesive 150 attaches the second diffusing layer 130 with the upper surface of the liquid crystal film 110.

A resin that may used for the second diffusing layers 130 may include a polycarbonate-based resin, a polysulfone-based resin, a polymethylmethacrylate-based resin, a polystyrene-based resin, a polyvinylchloride-based resin, a polyvinylalcohol-based resin, a polynorbornene-based resin, etc., either alone or in a combination thereof. Therefore, the second diffusing layer 130 may prevent the deformation of the liquid crystal film 110 resulting from the heat and/or the moisture.

A diffusing material may be added to the second diffusing layer 130 to diffuse a light that is supplied to the second diffusing layer 130. A cationic surfactant may be added to the second diffusing layer 130 to prevent static electricity from being provided to the liquid crystal film 110.

The second ultraviolet adhesive 150 may be cured by exposes an ultraviolet thereto to attach the second diffusing layer 130 with the lower surface of the liquid crystal film 110. The second ultraviolet adhesive 150 may include a photopolymerizeable initiator, a photopolymerizeable monomer, and a photopolymerizeable oligomer. The photopolymerizeable initiator may include an acetophenone-based initiator, a benzophenone-based initiator, or a thioxanthone-based initiator, or the like. The photopolymerizeable monomer may include an acrylate-based monomer, an epoxy acrylate-based monomer, a polyester acrylate-based monomer, an urethane acrylate-based monomer, or the like. Examples of the photopolymerizeable oligomer may include an acrylate-based oligomer, an epoxy acrylate-based oligomer, a polyester acrylate-based oligomer, an urethane acrylate-based oligomer, etc.

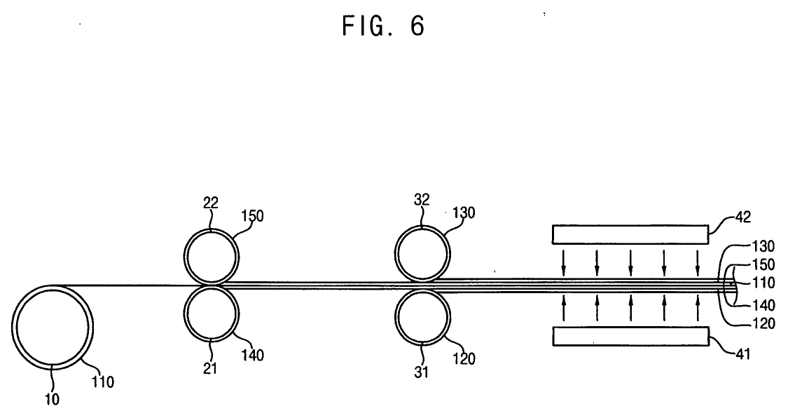

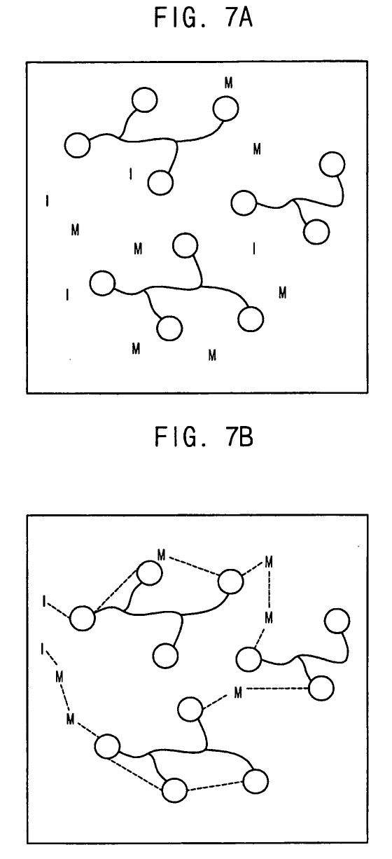

FIG. 6 is a cross-sectional view illustrating a process for manufacturing the diffusely reflective polarizing film in FIG. 1. FIG. 7A is a view showing first and second ultraviolet adhesives before being cured by ultraviolet light shown in FIG. 1. FIG. 7B is a view showing first and second ultraviolet adhesives after being cured by ultraviolet light shown in FIG. 1.

Referring to FIG. 6, a first roller 10 rotates in a predetermined direction to move the liquid crystal film 110, a second roller 21 is positioned adjacent to an upper side, e.g., a top portion, of the liquid crystal film 110, and a third roller 22 is positioned adjacent to a lower side, e.g., a bottom portion, of the liquid crystal film 110. The second roller 21 and the third roller 22 rotate in a predetermined direction to coat the first and second ultraviolet adhesives 140 and 150 on the upper and lower surfaces of the liquid crystal film 110, respectively. The first roller 21 faces the second roller 22 and the liquid crystal film moves therebetween.

A fourth roller 31 and a fifth roller 32 are positioned adjacent to the upper and lower sides of the liquid crystal film 110 where the first and second ultraviolet adhesives 140 and 150 are coated or the liquid crystal film 110, respectively. The fourth roller 31 and the fifth roller 32 rotate in a predetermined direction to coat the first and second diffusing layers 120 and 130 on a lower surface of the first ultraviolet adhesive 140 and an upper surface of the second ultraviolet adhesive 150, respectively.

As shown in FIG. 7A, before being cured by ultraviolet light, the first and second ultraviolet adhesives 140 and 150 includes a photo-crosslinkable polymer solution having an ultraviolet initiator, a photopolymerizeable monomer, and a photopolymerizeable oligomer.

A first ultraviolet irradiator 41 and a second ultraviolet irradiator 42 are positioned at the upper and lower sides of the liquid crystal film 110 on which the first and second diffusing layers 120 and 130 are coated, respectively. The first and second ultraviolet irradiators 41 and 42 irradiate ultraviolet light onto the liquid crystal film 110 on which the first and second diffusing layers 120 and 130 are coated. The first and second ultraviolet adhesives 140 and 150 are cured by exposing ultraviolet light thereto, so that the first and second diffusing layers 120 and 130 are fixed to or attached with the liquid crystal film 110.

As shown in FIG. 7B, when the ultraviolet light irradiates upon the first and second ultraviolet adhesives 140 and 150, the ultraviolet initiator, the photopolymerizeable monomer, and the photopolymerizeable oligomer are photopolymerized by the ultraviolet light. For example, when the ultraviolet light irradiates upon the first and second ultraviolet adhesives 140 and 150 including methylmethacrylate, the first and second ultraviolet adhesives 140 and 150 are converted into polymethylmethacrylate in response to the ultraviolet light.

When the first and second ultraviolet adhesive materials 140 and 150 are cured via the photopolymerization process, the first and second diffusing layers 120 and 130 are attached with the liquid crystal film 110 by the first and second ultraviolet adhesives 140 and 150, respectively.

As a result, the diffusely reflective polarizing film 101 including the first and second diffusing layers 120 and 130 attached with the upper and lower surfaces of the liquid crystal film 110, respectively, is completed.

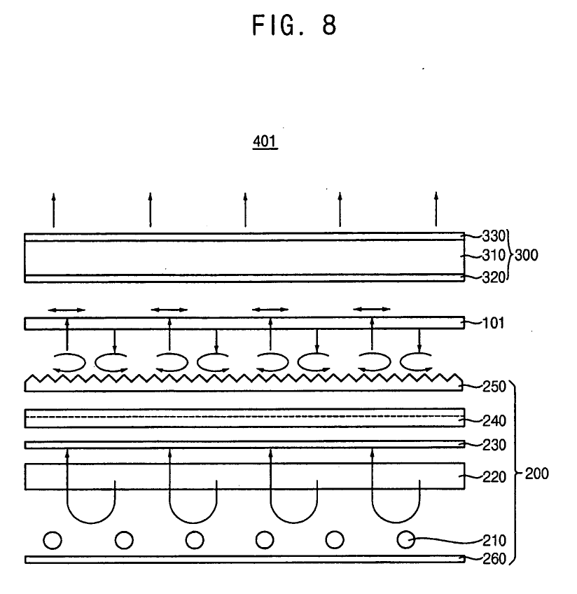

FIG. 8 is a cross-sectional view showing a display apparatus having a diffusely reflective polarizing film shown in FIG. 1. In FIG. 8, the same reference numerals denote the same elements shown in FIG. 1 and any repetitive descriptions of the same elements are omitted as necessary.

Referring to FIG. 8, a display apparatus 401 includes a backlight assembly 200 that generates light, the diffusely reflective polarizing film 101 that polarizes the light, and a display unit 300 that displays an image using the light.

The backlight assembly 200 may include a plurality of lamps 210 to generate the light and a diffusing plate 220 disposed on the lamps 210 to diffuse the light. The lamps 210 may have a substantially stick-like shape and are arranged substantially parallel with each other. The diffusing plate 220 diffuses the light emitted from the lamps 210 to improve a brightness uniformity of the light.

The backlight assembly 200 may further include a diffusing sheet 230 that further diffuses the light, first and second prism sheets 240 and 250 that collect the light, the first and second prism sheets 240 and 250 are provided on the diffusing plate 220, to improve a viewing angle and a front brightness of the display. The backlight assembly 200 may further include a reflecting sheet 260 provided under the lamps 210 that reflects the light toward the diffusing plate 220 to improve a light efficiency of the backlight assembly 200.

The display unit 300 is provided over the backlight assembly 200 and includes a display panel 310 that displays the image using the light, a first polarizing plate 320 that polarizes light that is supplied to the display panel 310, and a second polarizing plate 330 that polarizes a light received from the display panel 310. The first polarizing plate 320 is attached with a lower surface of the display panel 310, and the second polarizing plate 330 is attached to an upper surface of the display panel 310.

The diffusely reflective polarizing film 101 is provided between the display unit 300 and the backlight assembly 200. The diffusely reflective polarizing film 101 may transmit a p-polarized component and diffusely reflects an s-polarized component of the light from the backlight assembly to polarize the light. The light reflected from the diffusely reflective polarizing film 101 is again reflected from the reflecting sheet 260 of the backlight assembly 200 and supplied to the diffusely reflective polarizing film 101. Therefore, most of the light from the backlight assembly may transmit the diffusely reflective polarizing film 101.

Table 2 represents average brightness of 13-points and 5-points of the display panel 310 according with Examples 1, 2, 3 and 4.

TABLE 2

| | Example 1 | Example 2 | Example 3 | Example 4 |
|---|---|---|---|---|
| Brightness average | 1,521 | 106 | 130 | 135 |
| (13-point) | | | | |
| Brightness average | 1,516 | 109 | 134 | 138 |
| (5-point) | | | | |
| x-coordinate | 0.3022 | 0.3136 | 0.3183 | 0.3197 |
| y-coordinate | 0.3048 | 0.3467 | 0.3550 | 0.3679 |
| Brightness uniformity | 76.3% | 69.7% | 73.1% | 75.9% |
| Brightness (13-point) | 100% | 7.0% | 8.6% | 8.8% |
| Brightness (5-point) | 100% | 7.2% | 8.8% | 9.1% |
| Brightness efficiency | | | 100% | 103.3% |
| (13-point) | | | | |
| Brightness efficiency | | | 100% | 102.5% |
| (5-point) | | | | |

In Table 2, Example 1 refers to a backlight assembly, Example 2 refers to a display apparatus that does not have the diffusely reflective polarizing film 101, Example 3 refers to a display apparatus having a dual brightness enhancement film and Example 4 refers to the display apparatus having the diffusely reflective polarizing film 101 according to an embodiment of the invention.

According to Table 2, the brightnesses (13-point and 5-point) of Example 2, Example 3, and Example 4 are increased in that order, the x and y coordinates of Example 2, Example 3, and Example 4 are increased in that order, and the brightness uniformities (13-point and 5-point) of Example 2, Example 3, and Example 4 are increased in that order.

Assuming that the brightnesses (13-point) measured in Example 1 is 100%, the brightness (13-point) in Example 2, Example 3, and Example 4 are represented by 7.0%, 8.6% and 8.8%, respectively. When assuming that the brightnesses (5-point) in Example 1 is 100%, the brightnesses (5-point) in Example 2, Example 3 and Example 4 have been represented by 7.2%, 8.8%, and 9.1%, respectively.

Assuming that the brightness efficiencies (13-point and 5-point) in Example 3 are 100%, the brightness efficiencies (13-point and 5-point) in Example 4 are 103.3% and 102.5%, respectively. As a result, the display apparatus 401 using the diffusely reflective polarizing film 101 according to an embodiment of the invention may improve a display quality by improving the brightness, the brightness uniformity, and the x and y coordinates.

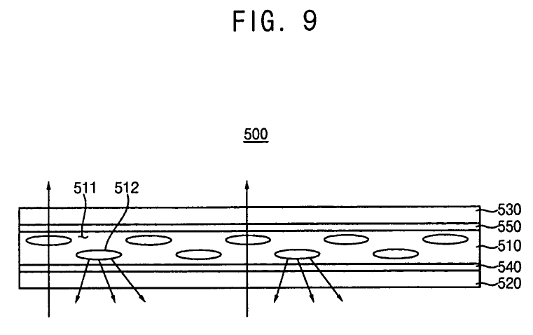

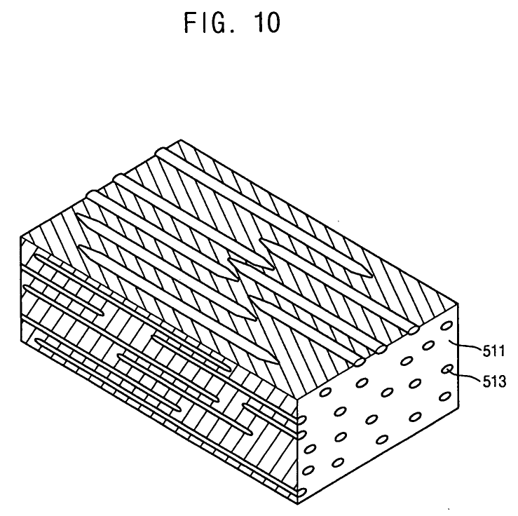

FIG. 9 is a view showing a diffusely reflective polarizing film according to another embodiment of the invention. FIG. 10 is a sectional perspective view schematically showing a base film shown in FIG. 9.

Referring to FIG. 9, a diffusely reflective polarizing film 500 may include a base film 511, a plurality of polarizing particles 512, a first diffusing layer 520, a second diffusing layer 530, a first ultraviolet adhesive material 540, and a second ultraviolet adhesive material 550.

A resin may used for the base film 511 that includes a polyethylenenaphthalate-based resin, a polycarbonate-based resin, a polysulfone-based resin, a polymethylmethacrylate-based resin, a polystyrene-based resin, a polyvinylchloride-based resin, a polyvinylalcohol-based resin, a polynorbornene-based resin, etc., either alone or a combination thereof.

The polarizing particles 512 may include a polyethyleneterephthalate-based copolymer (Co-PET) and are included in the base film 511 in a disperse phase. The Co-PET may include a bisphenol-based compound of formula (1).

The polarizing particles 512 may include the Co-PET polymerized from a bisphenol-based monomer of formula (1), an ethylene glycol-based monomer, and a carboxylic acid-based monomer. 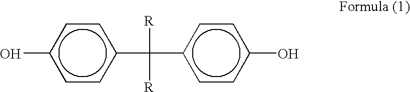
wherein the ‘R’ denotes H or CH₃.

The polarizing particles 512 have a specific gravity of approximately 1.22 g/cm², a refractive index of approximately 1.607, and a thermal deflection temperature of approximately 105° C. Thus, the polarizing particles 512 have a high refractive index and a low birefringence. The polarizing particles 512 added into the base film 511 have a weight percent ranging from between approximately 0.01% to approximately 40%, and preferably the weight percent ranges between approximately one percent to approximately thirty percent.

The polarizing particles 512 extend so that a p-polarized component transmits the polarizing particles 512 and an s-polarized component is reflected from the polarizing particles 512. The polarizing particles 512 have a first axis to transmit the p-polarized component and a second axis to diffusely reflect the s-polarized component. The first axis of the polarizing particles 512 may be substantially perpendicular to the second axis of the polarizing particles 512, which extend along the first axis direction. An expansion ratio of the first axis direction with respect to the second axis direction ranges between approximately one to approximately ten times, and preferably in a range between approximately two to approximately seven times.

The p-polarized component of a light that is supplied to the base film 511 is transmitted through the polarizing particles 512. The s-polarized component of a light that is supplied to the base film 512 is diffusely reflected by the polarizing particles 512. The s-polarized component that is converted into the p-polarized component by the polarizing particles 512 is incident upon the base film 511 and transmits the polarizing particles 512. Most of the light supplied to the base film 511 transmits the polarizing particles 512. Therefore, the diffusely reflective polarizing film 500 may improve a brightness of the display apparatus.

The first and second diffusing layers 520 and 530 are provided on an upper side and a lower side of the base film 511, respectively, to diffuse the light. A resin that may be used for the first and second diffusing layers 520 and 530 may include a polycarbonate-based resin, a polysulfone-based resin, a polymethylmethacrylate-based resin, a polystyrene-based resin, a polyvinylchloride-based resin, a polyvinyl alcohol-based resin, a polynorbornene-based resin, etc., either alone or a combination thereof. The first and second diffusing layers 520 and 530 diffuse the light and provide protection to the base film 511 from the heat, which prevents or significantly reduces the warping phenomenon of the base film 511 resulting from the heat.

A diffusing agent (not shown) may be added to the first and second diffusing layers 520 and 530 to diffuse the light that is supplied to the first and second diffusing layers 520 and 530. The diffusing agent may include a silicon diffusing agent, a magnesium diffusing agent, or a calcium carbonate diffusing agent. A cationic surfactant may be added to the first and second diffusing layers 520 and 530 to prevent the static electricity from being provided to the base film 511.

Alternatively, the first and second ultraviolet adhesives 540 and 550 may include a material that is cured by an exposure to an ultraviolet light to attach the first and second diffusing layers 520 and 530 with the lower and upper surfaces of the base film 511, respectively. The first and second ultraviolet adhesives 540 and 550 may include a photopolymerizeable initiator, a photopolymerizeable monomer, and a photopolymerizeable oligomer.

The photopolymerizeable initiator may include an acetophenone-based initiator, a benzophenone-based initiator, a thioxanthone-based initiator, or the like. The photopolymerizeable monomer may include an acrylate-based monomer, an epoxy acrylate-based monomer, a polyester acrylate-based monomer, an urethane acrylate-based monomer, or the like. The photopolymerizeable oligomer may include an acrylate-based oligomer, an epoxy acrylate-based oligomer, a polyester acrylate-based oligomer, an urethane acrylate-based oligomer, or the like.

The diffusely reflective polarizing film 500 may include a diffusing layer (not shown) that is provided on at least one of the upper surface and the lower surface of the base film 511.

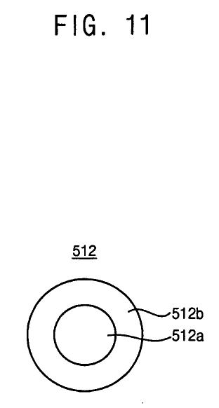

FIG. 11 is a cross-sectional view showing an organic particle that is added to the base film shown in FIG. 9.

Referring to FIG. 11, the organic particle 513 has a core-shell structure and is added into the base film 511.

The organic particles 513 may include methacrylate butadiene styrene. A core or center portion 513a of the organic particles 513 may include a butadiene and a styrene cross-linked to the butadiene. A shell portion 513b of the organic particles 513 may include polymethylmethacrylate surrounding the core portion 513a. Although not shown in figures, the butadiene and the styrene in the core portion 513a may be coupled with each other in a mesh-like-shape.

The diffusely reflective polarizing films 510 have different refractive indexes from each other between a first direction where the organic particles 513 and are extended a second direction where the organic particles 513 are not extended. Therefore, a P-polarized component of the light that is supplied to the base film 511 transmits the organic particles 513, and an S-polarized component of the light that is supplied to the base film 511 is diffusely reflected by the organic particles 513.

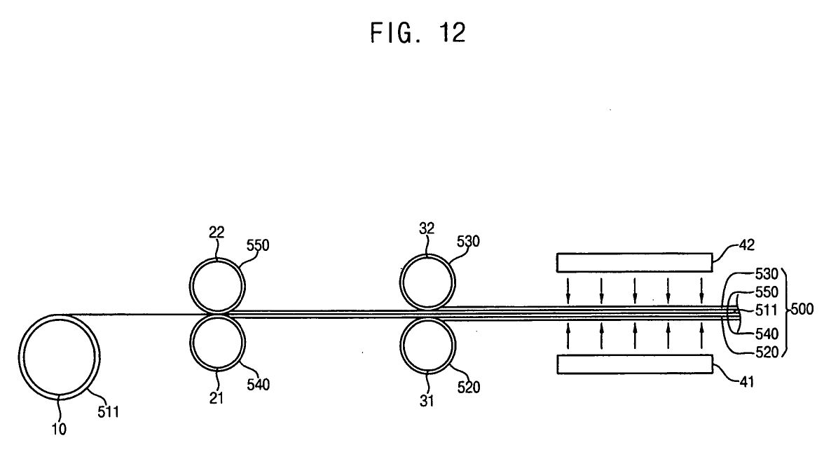

FIG. 12 is a cross-sectional view illustrating a process for manufacturing the diffusely reflective polarizing film shown in FIG. 9. In FIG. 12, the same reference numerals denote the same elements shown in FIG. 6 and any repetitive descriptions of the same elements are omitted as necessary.

Referring to FIG. 12, the first roller 10 rotates in a predetermined direction to move the base film 511 in a first direction D1. The second and third rollers 21 and 22 are positioned adjacent to the upper side and the lower side of the base film 511. The second and third rollers 21 and 22 rotate in a predetermined direction to coat the first and second ultraviolet adhesives 540 and 550 on the upper and lower surfaces of the base film 511, respectively.

The fourth and fifth rollers 31 and 32 are positioned adjacent to the upper and lower sides of the base film 511 on which the first and second ultraviolet adhesives 540 and 550 are coated, respectively. The fourth and fifth rollers 31 and 32 rotate in a predetermined direction to coat the first and second diffusing layers 520 and 530 on a lower surface of the first ultraviolet adhesive 540 and on an upper surface of the second ultraviolet adhesive 550, respectively.

The first and second ultraviolet irradiators 41 and 42 are positioned adjacent to the upper and lower sides of the base film 511 on which the first and second diffusing layers 520 and 530 are coated, respectively. The first and second ultraviolet irradiators 41 and 42 irradiate ultraviolet light onto the base film 511 on which the first and second diffusing layers 520 and 530 are coated. The first and second ultraviolet adhesives 540 and 550 are cured by the exposure to the ultraviolet light, which fixes or attaches the first and second diffusing layers 520 and 530 are fixed to the base film 511.

According to the above described process, the diffusely reflective polarizing film 500 includes the first and second diffusing layers 520 and 530 attached to the upper and lower surfaces of the base film 511, respectively.

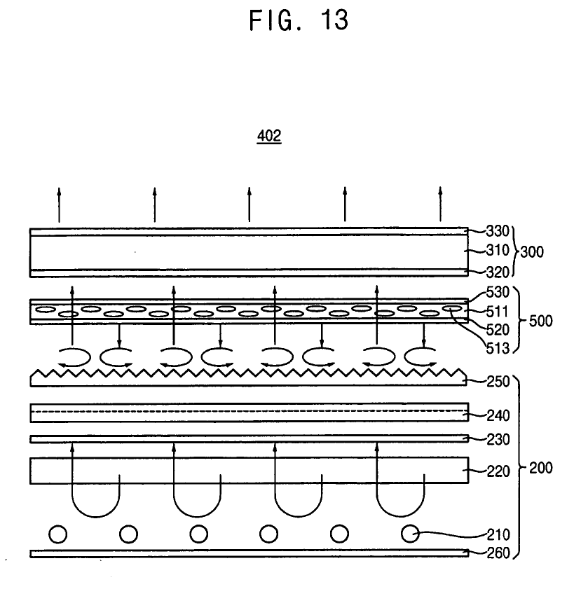

FIG. 13 is a cross-sectional view showing a display apparatus having a diffusely reflective polarizing film shown in FIG. 9. In FIG. 13, the same reference numerals denote the same elements as shown in FIG. 8 and FIG. 9, and any repetitive descriptions of the same elements are omitted as necessary.

Referring to FIG. 13, a display apparatus 402 includes the backlight assembly 200 that generates light, the diffusely reflective polarizing film 500 that polarizes the light, and the display unit 300 that displays an image using the light.

The diffusely reflective polarizing film 500 is provided between the display unit 300 and the backlight assembly 200. The diffusely reflective polarizing film 500 polarizes the light by transmitting a P-polarized component and diffusely reflecting an S-polarized component of the light generated from the backlight assembly 200. The light reflected from the diffusely reflective polarizing film 500 is again reflected from the reflecting sheet 260 of the backlight assembly 200 and supplied to the diffusely reflective polarizing film 500. Therefore, most of the light from the backlight assembly is transmitted through the diffusely reflective polarizing film 500.

Table 3 represents average brightness of 13-points of the display panel 310 in accordance with Examples 1, 2, 3, and 4.

TABLE 3

| | Example 1 | Example 2 | Example 3 | Example 4 |
|---|---|---|---|---|
| Brightness average | 1,521 | 106 | 130 | 130 |
| (13-point) | | | | |
| x-coordinate | 0.3022 | 0.3136 | 0.3183 | 0.3183 |
| y-coordinate | 0.3048 | 0.3467 | 0.3550 | 0.3550 |
| Brightness uniformity | 76.3% | 69.7% | 73.1% | 73.1% |
| Brightness (13-point) | 100% | 7.0% | 8.6% | 8.6% |
| Brightness efficiency | | | 100% | 100% |
| (13-point) | | | | |

In Table 3, Example 1 refers to a backlight assembly, Example 2 refers to a display apparatus that does not have the diffusely reflective polarizing film, Example 3 refers to a display apparatus having a dual brightness enhancement film and Example 4 refers to the display apparatus having the diffusely reflective polarizing film 500 according to another embodiment of the invention.

According to Table 3, the brightness of Example 2 is less than the brightnesses of Example 3 and Example 4. The x and y coordinates of Example 2 are less than the x and y coordinates of Example 3 and Example 4. The brightness uniformity of Example 2 is less than the brightness uniformity of Example 3 and Example 4.

When assuming that the brightness measured in Example 1 is 100%, the brightnesses in Example 2, Example 3, and Example 4 are 7.0%, 8.6% and 8.6%, respectively. When assuming that the brightness efficiency in Example 3 is 100%, the brightness efficiency in Example 4 is also 100%.

As a result, the display apparatus 402 employing the diffusely reflective polarizing film 500 according to an embodiment of the invention may improve the display quality by improving the brightness, brightness uniformity, and x and y coordinate values.

In Table 3, the brightness efficiency in Example 3 using the dual brightness enhancement film is the same or substantially the same as the brightness efficiency in Example 4. However, the dual brightness enhancement film of Example 3 has a multi-layered structure that includes hundreds or thousands of layers, thereby complicating the manufacturing process. On the contrary, manufacturing the diffusely reflective polarizing film 500 is much simpler and less expensive than manufacturing the dual brightness enhancement film.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A diffusely reflective polarizing film, comprising:
a liquid crystal film having a cholesteric liquid crystal to reflect a first component of an incident light and to transmit a second component of the incident light; and
a diffusing layer attached with the liquid crystal film,
wherein the first component is substantially parallel with a rotated axis of the cholesteric liquid crystal, and the second component is different than the first component.

2. The film of claim 1, wherein the diffusing layer comprises:
a first diffusing layer attached with a lower surface of the liquid crystal film and that diffuses a light supplied to the liquid crystal film; and
a second diffusing layer attached with an upper surface of the liquid crystal film and that diffuses the light supplied from the liquid crystal film.

3. The film of claim 1, wherein the diffusing layer comprises at least one resin selected from the group consisting of a polycarbonate-based resin, a polysulfone-based resin, a polymethylmethacrylate-based resin, a polystyrene-based resin, a polyvinylchloride-based resin, a polyvinylalcohol-based resin, and a polynorbornene-based resin.

4. The film of claim 1, wherein the diffusing layer further comprises a diffusing agent that diffusesa light supplied to the diffusing layer.

5. The film of claim 4, wherein the diffusing agent comprises a silicon diffusing agent, a magnesium diffusing agent, or a calcium carbonate diffusing agent.

6. The film of claim 1, wherein the diffusing layer further comprises a cationic surfactant that insulates the liquid crystal film from static electricity.

7. The film of claim 1, further comprising an adhesive including an ultraviolet-curable material that attaches the diffusing layer with the liquid crystal film.

8. The film of claim 7, wherein the adhesive comprises a photopolymerizeable initiator and a photopolymerizeable monomer, or a photopolymerizeable oligomer,
wherein the photopolymerizeable initiator comprises at least one initiator selected from the group consisting of an acetophenone-based initiator, a benzophenone-based initiator, and a thioxanthone-based initiator,
wherein the photopolymerizeable monomer comprises at least one monomer selected from the group consisting of an acrylate-based monomer, an epoxy acrylate-based monomer, a polyester acrylate-based monomer, and an urethane acrylate-based monomer, and
wherein the photopolymerizeable oligomer comprises at least one oligomer selected from the group consisting of an acrylate-based oligomer, an epoxy acrylate-based oligomer, a polyester acrylate-based oligomer, and an urethane acrylate-based oligomer.

9. The film of claim 1, wherein the liquid crystal film comprises:
a base layer;
a liquid crystal layer provided on the base layer and having the cholesteric liquid crystal to circularly polarize light supplied from the base layer; and
a retardation layer to linearly polarize the circularly polarized light from the liquid crystal layer.

10. The film of claim 9, wherein the liquid crystal layer comprises:
a first liquid crystal layer to circularly polarize a light having a red wavelength range;
a second liquid crystal layer to circularly polarize a light having a green wavelength range; and
a third liquid crystal layer to circularly polarize a light having a blue wavelength range.

11. The film of claim 10, wherein the first liquid crystal layer, the second liquid crystal layer and the third liquid crystal layer are stacked on the base layer.

12. The film of claim 11, wherein the liquid crystal film further comprises:
a first adhesive attaching the first liquid crystal layer with the base layer;
a second adhesive attaching the second liquid crystal layer with the first liquid crystal layer; and
a third adhesive attaching the third liquid crystal layer with the second liquid crystal layer.

13. The film of claim 10, wherein the first liquid crystal layer comprises the cholesteric liquid crystal and a vertical alignment liquid crystal that are mixed at a ratio of approximately 8:2, respectively.

14. The film of claim 10, wherein the second liquid crystal layer comprises the cholesteric liquid crystal and a vertical alignment liquid crystal that are mixed at a ratio of approximately 7:3, respectively.

15. The film of claim 10, wherein the third liquid crystal layer comprises the cholesteric liquid crystal and a vertical alignment liquid crystal that are mixed at a ratio of approximately 6:4, respectively.

16. The film of claim 9, wherein the base layer comprises a polyethyleneterephthalate-based resin.

17. The film of claim 9, wherein the retardation layer comprises a λ/4 retardation layer, and a z-axis refractive index of the retardation layer is larger than a refractive index of the retardation layer with respect to an x-y plane of the retardation layer.

18. The film of claim 17, wherein the retardation layer has a phase delay of about 110 nm to about 125 nm.

19. The film of claim 1, wherein the diffusing layer is attached with a lower surface of the liquid crystal film to diffuse a light supplied to the liquid crystal film.

20. The film of claim 1, wherein the diffusing layer is attached with an upper surface of the liquid crystal film to diffuse a light supplied from the liquid crystal film.

21. A diffusely reflective polarizing film, comprising:
a base film; and
a plurality of polarizing particles comprising a copolymer,
wherein the base film comprises the polarizing particles to transmit a first component of a light supplied to the base film and to diffusely reflect a second component of the light.

22. The film of claim 21, wherein the polarizing particles comprise a polyethyleneterephthalate copolymer.

23. The film of claim 22, wherein the polarizing particles comprises a following bisphenol-based compound of formula

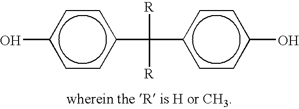

24. The film of claim 22, wherein the polarizing particles comprise a copolymer having a polymerization of a bisphenol-based monomer, an ethylene glycol-based monomer, and a carboxylic acid-based monomer.

25. The film of claim 21, wherein a weight percent of the polarizing particles is of about 0.01% to about 40%.

26. The film of claim 25, wherein the weight percent is of about 1% to about 30%.

27. The film of claim 21, wherein the polarizing particles are expanded such that a first axis direction of the polarizing particles is substantially perpendicular to a second axis direction of the polarizing particles, and
wherein an expansion ratio of the first axis direction with respect to the second axis direction is of about one to about ten times.

28. The film of claim 27, wherein the expansion ratio is of about two to about seven times.

29. The film of claim 21, wherein the polarizing particles have a specific gravity of about 1.22 g/cm.

30. The film of claim 21, wherein the polarizing particles have a refractive index of about 1.607.

31. The film of claim 21, wherein a thermal deflection temperature of the polarizing particles is about 105° C.

32. The film of claim 21, wherein the base film comprises at least one resin selected from the group consisting of a polyethylenenaphthalate-based resin, a polycarbonate-based resin, a polysulfone-based resin, a polymethylmethacrylate-based resin, a polyvinylchloride-based resin, a polyvinylalcohol-based resin, and a polynorbornene-based resin.

33. The film of claim 21, further comprising a diffusing layer provided on a lower surface or an upper surface of the base film.

34. The film of claim 33, wherein the diffusing layer comprises at least one resin selected from the group consisting of a polycarbonate-based resin, a polyethyleneterephthalate-based resin, a polyimide-based resin, a polysulfone-based resin, a polymethylmethacrylate-based resin, a polystyrene-based resin, a polyvinylchloride-based resin, a polyvinylalcohol-based resin, and a polynorbornene-based resin.

35. A diffusely reflective polarizing film, comprising:
a base film;
a plurality of organic particles provided in the base film to transmit a first component of a light supplied to the base film and diffusely reflect a second component of the light; and
a diffusing layer attached with the base film.

36. The film of claim 35, wherein the diffusing layer comprises:
a first diffusing layer attached with a lower surface of the base film to diffuse the light supplied to the base film; and
a second diffusing layer attached with an upper surface of base film to diffuse a light supplied from the base film.

37. The film of claim 35, wherein the diffusing layer comprises at least one resin selected from the group consisting of a polycarbonate-based resin, a polyethyleneterephthalate-based resin, a polyimide-based resin, a polysulfone-based resin, a polymethylmethacrylate-based resin, a polystyrene-based resin, a polyvinylchloride-based resin, a polyvinylalcohol-based resin, and a polynorbornene-based resin.

38. The film of claim 37, wherein the diffusing layer further comprises a diffusing agent to diffuse a light supplied to the diffusing layer.

39. The film of claim 38, wherein the diffusing agent comprises a silicon diffusing agent, a magnesium diffusing agent, or a calcium carbonate diffusing agent.

40. The film of claim 35, wherein the diffusing layer further comprises a cationic surfactant to that insulates the liquid crystal layer from static electricity.

41. The film of claim 35, further comprising an adhesive comprising an ultraviolet-curable material to attach the diffusing layer with the base film.

42. The film of claim 41, wherein the adhesive comprises a photopolymerizeable initiator and a photopolymerizeable monomer, or a photopolymerizeable oligomer,
wherein the photopolymerizeable initiator comprises at least one initiator selected from the group consisting of an acetophenone-based initiator, a benzophenone-based initiator, and a thioxanthone-based initiator,
wherein the photopolymerizeable monomer comprises at least one monomer selected from the group consisting of an acrylate-based monomer, an epoxy acrylate-based monomer, a polyester acrylate-based monomer, and an urethane acrylate-based monomer, and
wherein the photopolymerizeable oligomer comprises at least one oligomer selected from the group consisting of an acrylate-based oligomer, an epoxy acrylate-based oligomer, a polyester acrylate-based oligomer, and an urethane acrylate-based oligomer.

43. The film of claim 35, wherein the base film comprises at least one resin selected from the group consisting of a polyethylenenaphthalate-based resin, a polycarbonate-based resin, a polyimide-based resin, a polysulfone-based resin, a polymethylmethacrylate-based resin, a polyvinylchloride-based resin, a polyvinylalcohol-based resin, and a polynorbornene-based resin.

44. The film of claim 35, wherein the organic particles comprise a plurality core-shell particles.

45. The film of claim 35, wherein the organic particles comprise:
a core portion comprising a butadiene and a styrene cross-linked to the butadiene; and
a shell portion comprising a polymethylmethacrylate and substantially surrounding the core portion.

46. A display apparatus, comprising:
a backlight assembly generating a light;
a diffusely reflective polarizing film provided on the backlight assembly and comprising:
a liquid crystal film comprising a cholesteric liquid crystal to reflect a first component of the light that is substantially parallel with a rotated axis of the cholesteric liquid crystal and to transmit a second component of the light that is different from the first component; and
a diffusing layer attached with the liquid crystal film, and
a display panel provided on the diffusely reflective polarizing film and that displays an image using a light supplied from the diffusely reflective polarizing film.

47. A display apparatus, comprising:
a backlight assembly generating a light;
a diffusely reflective polarizing film provided on the backlight assembly and comprising:
a base film; and
a plurality of polarizing particles comprising a copolymer, and
a display panel provided on the diffusely reflective polarizing film and that displays an image using a light from the diffusely reflective polarizing film,
wherein the base film comprises the polarizing particles to transmit a first component of a light supplied to the base film and to diffusely reflect a second component of the light.

48. A display apparatus, comprising:
a backlight assembly generating a light;
a diffusely reflective polarizing film provided on the backlight assembly and comprising:
a base film;
a plurality of organic particles provided in the base film to transmit a first component of a light supplied to the base film and to diffusely reflect a second component of the light; and
a diffusing layer attached with the base film, and
a display panel provided on the diffusely reflective polarizing film and that displays an image using a light from the diffusely reflective polarizing film.

49. A method of manufacturing a diffusely reflective polarizing film, comprising:
forming a liquid crystal film having a cholesteric liquid crystal to reflect a first component of a light and to transmit a second component of the light, the first component is substantially parallel with a rotated axis of the cholesteric liquid crystal and the second component is different from the first component; and
attaching a diffusing layer with the liquid crystal film.

50. The method of claim 49, wherein forming the liquid crystal film comprises:
forming a liquid crystal layer comprising the cholesteric liquid crystal on a base layer to circularly polarize a light from the base layer;
curing the liquid crystal layer; and
forming a retardation layer on the liquid crystal layer to linearly polarize the circularly polarized light.

51. The method of claim 50, wherein forming the liquid crystal layer further comprises:
mixing the cholesteric liquid crystal with a vertical alignment liquid crystal; and
adding an ultraviolet initiator to the mixture.

52. The method of claim 51, wherein curing the liquid crystal layer comprises:
irradiating an ultraviolet light upon the liquid crystal layer.

53. The method of claim 49, wherein attaching the diffusing layer with the liquid crystal film comprises:
applying an ultraviolet adhesive on the liquid crystal film;
applying the diffusing layer on the ultraviolet adhesive; and
curing the ultraviolet adhesive to attach the diffusing layer with the liquid crystal film.

54. A method of manufacturing a diffusely reflective polarizing film, comprising:
expanding a base film that comprises a plurality of organic particles comprising a core-shell-like structure; and
attaching a diffusing layer with the base film.

55. The method of claim 54, wherein attaching the diffusing layer with the base film comprises:
applying an ultraviolet adhesive on the base film;
applying the diffusing layer on the ultraviolet adhesive; and
curing the ultraviolet adhesive to attach the diffusing layer with the base film.
